(19) United States
(12) Patent Application Publication
(10) Pub. No.: US 2024/0430935 A1
(43) Pub. Date: Dec. 26, 2024

(54) TRANSMISSION APPARATUS, RECEPTION APPARATUS, AND COMMUNICATION SYSTEM

(71) Applicant: SONY SEMICONDUCTOR SOLUTIONS CORPORATION, KANAGAWA (JP)

(72) Inventors: AKIHIRO MUKAI, KANAGAWA (JP); TAKAHIRO CHIBA, KANAGAWA (JP); MICHITO ISHII, KANAGAWA (JP)

(21) Appl. No.: 18/262,916

(22) PCT Filed: Dec. 27, 2021
(86) PCT No.: PCT/JP2021/048506

§ 371 Date: Jul. 25, 2023

(30) Foreign Application Priority Data
Feb. 2, 2021 (JP) 2021-014813

(51) Int. Cl. H04W 74/0816; H04W 24/08; H04W 88/04

(52) U.S. Cl. CPC H04W 74/0816; H04W 24/08; H04W 88/04

(57) ABSTRACT

The present technology relates to a transmission apparatus, a reception apparatus, and a communication system that can reduce omission of information caused by interruption of wireless communication. The communication system of the present technology includes a transmission apparatus and a reception apparatus. The transmission apparatus includes a communication section that transmits, in a case where wireless communication with one of multiple receivers that perform wireless communication with each other is interrupted, a transmission signal including the substance of a signal that has been transmitted directly to an unconnected receiver, to a connected receiver. The reception apparatus includes the multiple receivers. The connected receiver includes an external communication section that receives the transmission signal transmitted from the transmission apparatus, and a mutual communication section that transmits a signal that is included in the transmission signal and that has been transmitted from the transmission apparatus to the unconnected receiver to the unconnected receiver. The unconnected receiver includes a mutual communication section that receives the signal transmitted from the connected receiver. The present technology can be applied to a communication system including, for example, a smartphone and fully independent type earphones.

### TECHNICAL FIELD

The present technology relates to a transmission apparatus, a reception apparatus, and a communication system, and particularly relates to a transmission apparatus, a reception apparatus, and a communication system that can reduce omission of information by interruption of wireless communication.

### BACKGROUND ART

Conventionally, in audio devices of the left-right separation type, in a case where wireless communication is interrupted between a transmission side apparatus and one of the devices, audio is outputted only from the device that does not suffer from the interruption of wireless communication. In this case, since the user is placed into a situation in which the user can hear only audio from only one of the devices, information is missed, making it difficult for the user to understand the substance of the audio.

For example, PTL 1 discloses a technology that reduces interruption of video or audio by selecting an optimum communication medium from among wired communication media and wireless communication media that connect a transmission apparatus and a reception apparatus to each other. Further, there is disclosed a technology which takes, in a case where the communication state is deteriorated, such a countermeasure as to increase the compression ratio or the like to reduce interruption and disturbance upon data reproduction.

### CITATION LIST

### Patent Literature

[PTL 1]

Japanese Patent Laid-open No. 2005-184567

### SUMMARY

### Technical Problem

According to the technique disclosed in PTL 1, transmission of an audio signal is performed using a communication medium whose communication state is good from among multiple communication media. Accordingly, in a case where communication that uses a wired communication medium and communication that uses a wireless communication medium are both interrupted, the audio is interrupted, causing the user to fail to understand the substance of the audio.

The present technology has been made in view of such a situation as just described and makes it possible to reduce omission of information caused by interruption of wireless communication.

### Solution to Problem

A transmission apparatus of a first aspect of the present technology includes a communication section that transmits, in a case where wireless communication thereof with one of multiple receivers that perform wireless communication with each other is interrupted, a transmission signal including substance of a signal that has been transmitted directly to an unconnected receiver that is the receiver with which wireless communication is interrupted, to a connected receiver that is the receiver with which wireless communication is not interrupted.

A reception apparatus of a second aspect of the present technology includes multiple receivers that perform wireless communication with each other, in which a connected receiver that is one of the receivers and whose wireless communication with a transmission apparatus is not interrupted includes an external communication section that receives a transmission signal that has been transmitted from the transmission apparatus and that includes substance of a signal that has been transmitted from the transmission apparatus directly to an unconnected receiver that is one of the receivers and whose wireless communication with the transmission apparatus is interrupted, and a mutual communication section that transmits a signal that is included in the transmission signal and that has been transmitted from the transmission apparatus to the unconnected receiver to the unconnected receiver, and the unconnected receiver includes a mutual communication section that receives the signal transmitted from the connected receiver.

A communication system of a third aspect of the present technology includes a transmission apparatus that includes a communication section that transmits, in a case where wireless communication with one of multiple receivers that perform wireless communication with each other is interrupted, a transmission signal including the substance of a signal that has been transmitted directly to an unconnected receiver that is one of the receivers and whose wireless communication is interrupted, to a connected receiver that is one of the receivers and whose wireless communication is not interrupted, and a reception apparatus that includes the multiple receivers, in which the connected receiver includes an external communication section that receives the transmission signal transmitted from the transmission apparatus, and a mutual communication section that transmits a signal that is included in the transmission signal and that has been transmitted from the transmission apparatus to the unconnected receiver to the unconnected receiver, and the unconnected receiver includes a mutual communication section that receives the signal transmitted from the connected receiver.

In the first aspect of the present technology, in a case where wireless communication with one of the multiple receivers that perform wireless communication with each other is interrupted, a transmission signal including the substance of a signal that has been transmitted directly to the unconnected receiver that is the receiver with which wireless communication is interrupted is transmitted to the connected receiver that is the receiver with which wireless communication is not interrupted.

In the second aspect of the present technology, a transmission signal that has been transmitted from the transmission apparatus and that includes the substance of a signal that has been transmitted from the transmission apparatus directly to the unconnected receiver that is one of the multiple receivers that perform wireless communication with each other and whose wireless communication with the transmission apparatus is interrupted is received by the connected receiver that is one of the multiple receivers and whose wireless communication with the transmission apparatus is not interrupted. Further, a signal that is included in the transmission signal and that has been transmitted from the transmission apparatus to the unconnected receiver is transmitted to the unconnected receiver. The signal transmitted from the connected receiver is received by the unconnected receiver.

In the third aspect of the present technology, in a case where wireless communication with one of the multiple receivers that perform wireless communication with each other is interrupted, a transmission signal including the substance of a signal that has been transmitted directly to the unconnected receiver that is one of the receivers and whose wireless communication is interrupted is transmitted from the transmission apparatus to the connected receiver that is one of the receivers and whose wireless communication is not interrupted. The transmission signal transmitted from the transmission apparatus is received by the connected receiver that is one of the multiple receivers, and a signal that is included in the transmission signal and that has been transmitted from the transmission apparatus to the unconnected receiver is transmitted to the unconnected receiver. The signal transmitted from the connected receiver is received by the unconnected receiver.

### BRIEF DESCRIPTION OF DRAWINGS

FIG. 1 is a diagram depicting an example of a configuration of a communication system according to an embodiment of the present technology.

FIG. 2 is a diagram depicting an example of a transmission signal in a first case.

FIG. 3 is a diagram depicting an example of a transmission signal in a second case.

FIG. 4 is a diagram depicting an example of a transmission signal in a third case.

FIG. 5 is a block diagram depicting an example of a hardware configuration of a wireless type transmitter.

FIG. 6 is a block diagram depicting an example of a functional configuration of the wireless type transmitter.

FIG. 7 is a block diagram depicting an example of a hardware configuration of a left wireless type receiver.

FIG. 8 is a block diagram depicting an example of a functional configuration of the left wireless type receiver.

FIG. 9 is a flow chart illustrating a process of the wireless type transmitter.

FIG. 10 is a flow chart illustrating a process of the left wireless type receiver.

### DESCRIPTION OF EMBODIMENT

In the following, a mode for carrying out the present technology is described. The description is given in the following order.
1. Overview of communication system
2. Configuration of apparatuses
3. Action of apparatuses
4. Modification

### 1. Overview of Communication System

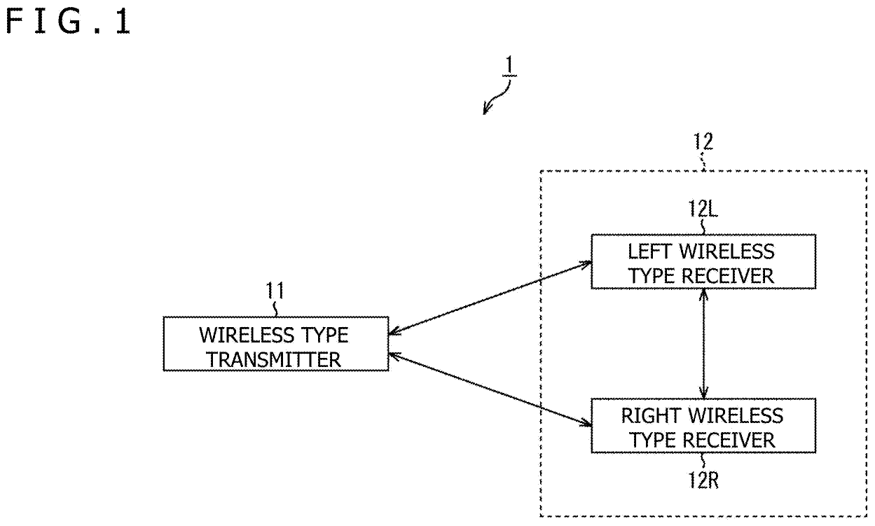

FIG. 1 is a diagram depicting an example of a configuration of a communication system 1 according to an embodiment of the present technology.

The communication system 1 of FIG. 1 includes a wireless type transmitter 11 and a wireless type receiver 12 connected to each other by wireless communication of Bluetooth (registered trademark), a wireless LAN, or the like. The wireless type receiver 12 includes a left wireless type receiver 12L and a right wireless type receiver 12R that are devices of housings different from each other. As indicated by double-sided arrow marks, wireless communication is performed between the wireless type transmitter 11 and the left wireless type receiver 12L and between the wireless type transmitter 11 and the right wireless type receiver 12R.

The wireless type transmitter 11 includes a smartphone, a tablet terminal, a PC, a portable player, a component stereo system, or the like. The wireless type transmitter 11 transmits an audio signal obtained by reproduction of content to the left wireless type receiver 12L and the right wireless type receiver 12R.

In a normal case, the wireless type transmitter 11 transmits, for example, an audio signal of the L channel to the left wireless type receiver 12L and transmits an audio signal of the R channel to the right wireless type receiver 12R.

The wireless type receiver 12 includes, for example, fully independent type earphones (inner ear headphone). The left wireless type receiver 12L is worn on the left ear of the user, and the right wireless type receiver 12R is worn on the right ear of the user.

The left wireless type receiver 12L and the right wireless type receiver 12R individually perform communication with the wireless type transmitter 11 independently of each other and output audio according to an audio signal transmitted from the wireless type transmitter 11. In a normal case, the left wireless type receiver 12L outputs audio for the left ear according to an audio signal of the L channel transmitted from the wireless type transmitter 11. The right wireless type receiver 12R outputs audio for the right ear according to an audio signal of the R channel transmitted from the wireless type transmitter 11.

As indicated by a double-sided arrow mark, the left wireless type receiver 12L and the right wireless type receiver 12R are connected to each other by wireless communication of Bluetooth, a wireless LAN, or NFMI (Near Field Magnetic Induction). Each of the left wireless type receiver 12L and the right wireless type receiver 12R suitably outputs audio according to an audio signal transmitted from the other receiver.

In such a manner, in the communication system 1 of FIG. 1, as paths of wireless communication, there are three paths including a path between the wireless type transmitter 11 and the left wireless type receiver 12L, another path between the wireless type transmitter 11 and the right wireless type receiver 12R, and a further path between the left wireless type receiver 12L and the right wireless type receiver 12R.

In a case where wireless communication with one of the left wireless type receiver 12L and the right wireless type receiver 12R is interrupted, the wireless type transmitter 11 generates a transmission signal according to communication states of the paths. The transmission signal generated according to the communication states is transmitted to a connected receiver that is the receiver with which wireless communication is not interrupted. The receiver that is one of the left wireless type receiver 12L and the right wireless type receiver 12R and with which wireless communication is not interrupted is hereinafter referred to as a “connected receiver,” and the other receiver with which wireless communication is interrupted is hereinafter referred to as an “unconnected receiver.”

First Case (Example in which Monaural Audio Signal is Transmitted)

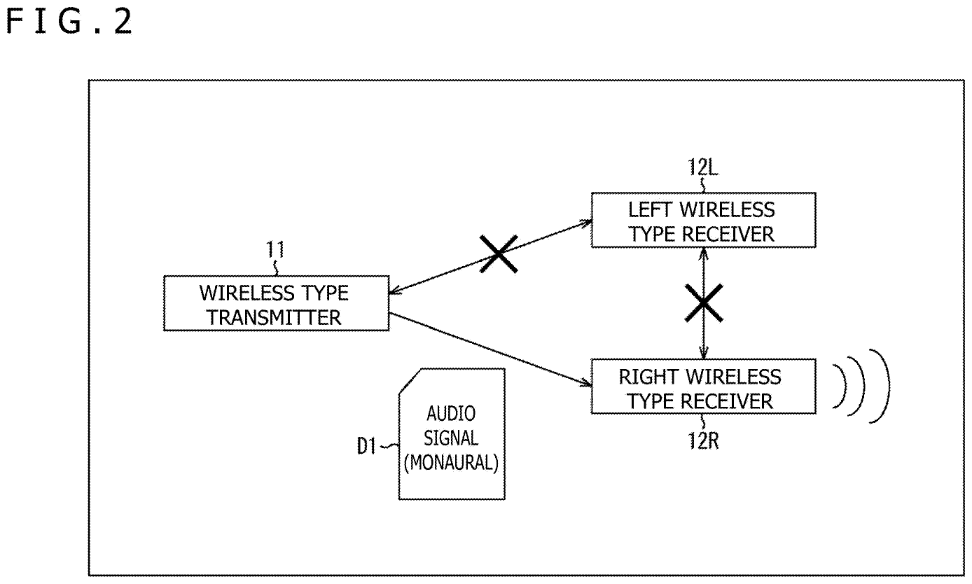

FIG. 2 is a diagram depicting an example of a transmission signal in a first case.

The first case is a case in which wireless communication between the left wireless type receiver 12L or the right wireless type receiver 12R and the wireless type transmitter 11 is interrupted and wireless communication between the left wireless type receiver 12L and the right wireless type receiver 12R is interrupted.

In the example of FIG. 2, the left wireless type receiver 12L is the unconnected receiver, and the right wireless type receiver 12R is the connected receiver.

In this case, the wireless type transmitter 11 generates a monaural audio signal D1 according to an audio signal of the L channel and an audio signal of the R channel and transmits the monaural audio signal D1 to the right wireless type receiver 12R that is the connected receiver. The monaural audio signal D1 includes a component of the audio signal of the L channel and a component of the audio signal of the R channel.

The right wireless type receiver 12R outputs audio according to the monaural audio signal D1 transmitted from the wireless type transmitter 11. Since the audio based on the monaural audio signal is outputted from the right wireless type receiver 12R, the communication system 1 can provide information represented by audio for the left ear and audio for the right ear without omission to the user. This makes it possible for the user to understand the substance of the audio.

Second Case (Example in which Transmission Signal Including Audio Signals of L Channel and R Channel is Transmitted)

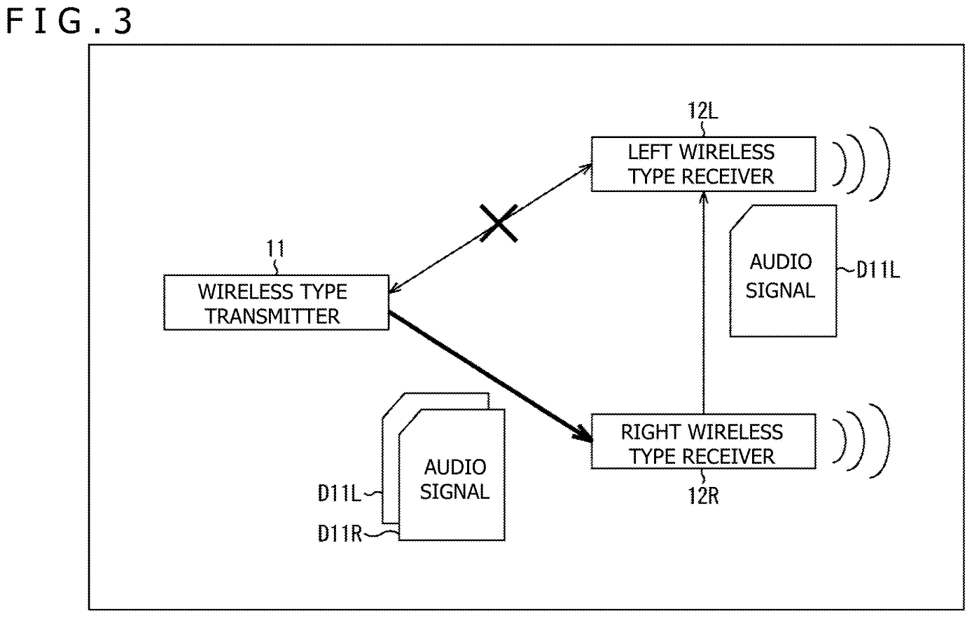

FIG. 3 is a diagram depicting an example of a transmission signal in a second case.

The second case is a case in which wireless communication between the left wireless type receiver 12L or the right wireless type receiver 12R and the wireless type transmitter 11 is interrupted and wireless communication between the left wireless type receiver 12L and the right wireless type receiver 12R is not interrupted.

In the example of FIG. 3, the left wireless type receiver 12L is the unconnected receiver, and the right wireless type receiver 12R is the connected receiver.

In the second case, it is assumed that the bandwidth of the communication path between the wireless type transmitter 11 and the right wireless type receiver 12R that is the connected receiver is sufficiently secured.

For example, the bandwidth of the communication path between the wireless type transmitter 11 and the right wireless type receiver 12R is greater than a predetermined threshold level. In FIG. 3, an arrow mark between the wireless type transmitter 11 and the right wireless type receiver 12R being indicated by a thick line arrow mark represents that the bandwidth of the communication path is greater than the predetermined threshold level. For example, a bandwidth with which both au audio signal of the L channel and an audio signal of the R channel can be transmitted together is set as the threshold level.

In this case, the wireless type transmitter 11 transmits a transmission signal including an audio signal D11L of the L channel and an audio signal D11R of the R channel together to the right wireless type receiver 12R.

The right wireless type receiver 12R receives the transmission signal transmitted from the wireless type transmitter 11 and transmits the audio signal D11L of the L channel to the left wireless type receiver 12L.

The left wireless type receiver 12L outputs audio according to the audio signal D11L of the L channel transmitted from the right wireless type receiver 12R. The right wireless type receiver 12R outputs audio according to the audio signal D11R of the R channel transmitted from the wireless type transmitter 11.

In such a manner, the left wireless type receiver 12L can receive the audio signal D11L of the L channel which should have been transmitted directly thereto from the wireless type transmitter 11, via the right wireless type receiver 12R.

Accordingly, the left wireless type receiver 12L and the right wireless type receiver 12R individually can receive the audio signals without any omission and output audio. This makes it possible for the communication system 1 to provide information which is represented by audio for the left ear and audio for the right ear, without any omission to the user.

Third Case (Example in which Transmission Signal of Low Bit Rate is Transmitted)

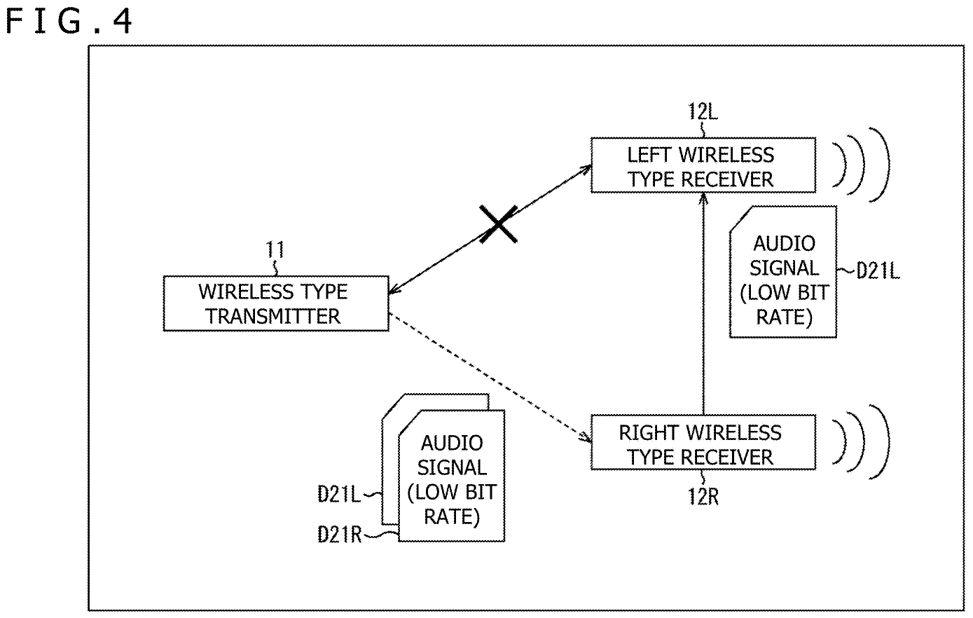

FIG. 4 is a diagram depicting an example of a transmission signal in a third case.

The third case is a case in which wireless communication between the left wireless type receiver 12L or the right wireless type receiver 12R and the wireless type transmitter 11 is interrupted and wireless communication between the left wireless type receiver 12L and the right wireless type receiver 12R is not interrupted, as in the second case.

In the example of FIG. 4, the left wireless type receiver 12L is the unconnected receiver, and the right wireless type receiver 12R is the connected receiver.

In the third case, it is assumed that the bandwidth of the communication path between the wireless type transmitter 11 and the right wireless type receiver 12R that is the connected receiver is not secured sufficiently.

For example, the bandwidth of the communication path between the wireless type transmitter 11 and the right wireless type receiver 12R is smaller than a predetermined threshold level. In FIG. 4, an arrow mark between the wireless type transmitter 11 and the right wireless type receiver 12R being indicated by a broken line arrow mark represents that the bandwidth of the communication path is smaller than the predetermined threshold level.

In this case, the wireless type transmitter 11 applies a lower bit rate to the transmission signal including an audio signal D21L of the L channel and an audio signal D21R of the R channel and transmits the low bit rate transmission signal to the right wireless type receiver 12R. For example, the low bit rate of the transmission signal is obtained by adjustment of the compression ratio.

For example, a transmission signal of a low bit rate is generated by generation of the audio signal D21L of the L channel of a low bit rate and the audio signal D21R of the R channel of a low bit rate and putting the audio signals together. A transmission signal of a low bit rate may be generated otherwise by application of a low bit rate to an audio signal of the L channel and an audio signal of the R channel together.

The right wireless type receiver 12R receives the transmission signal of the low bit rate transmitted from the wireless type transmitter 11 and transmits the audio signal D21L of the L channel of the low bit rate to the left wireless type receiver 12L.

The left wireless type receiver 12L outputs audio according to the audio signal D21L of the L channel of the low bit rate transmitted thereto from the right wireless type receiver 12R. The right wireless type receiver 12R outputs audio according the audio signal D21R of the R channel of the low bit rate transmitted from the wireless type transmitter 11.

In such a manner, also in a case where the bandwidth of the communication path between the wireless type transmitter 11 and the right wireless type receiver 12R is not secured sufficiently, the left wireless type receiver 12L can receive the audio signal of the L channel which should have been transmitted directly thereto from the wireless type transmitter 11, in a low bit rate state via the right wireless type receiver 12R. Also in a case where audio is outputted according to the low bit rate audio signal, the user can understand information represented by the audio, as in a case where audio is outputted according to an audio signal that is not of the low bit rate.

Accordingly, it is possible for the communication system 1 to provide information represented by audio for the left ear and audio for the right ear without omission to the user.

In the manner described above, in the communication system 1, in a case where wireless communication between the wireless type transmitter 11 and a receiver is interrupted, a transmission signal including the substance of an audio signal that has been transmitted to the unconnected receiver is transmitted to the connected receiver. Also in a case where the right wireless type receiver 12R is the unconnected receiver and the left wireless type receiver 12L is the connected receiver, similar processes are performed.

Consequently, also in a case where communication between the left wireless type receiver 12L or the right wireless type receiver 12R and the wireless type transmitter 11 is interrupted, such a situation that audio is interrupted and the user faces difficulty in understanding the substance of audio can be prevented.

### 2. Configuration of Apparatuses

### Configuration of Wireless Type Transmitter

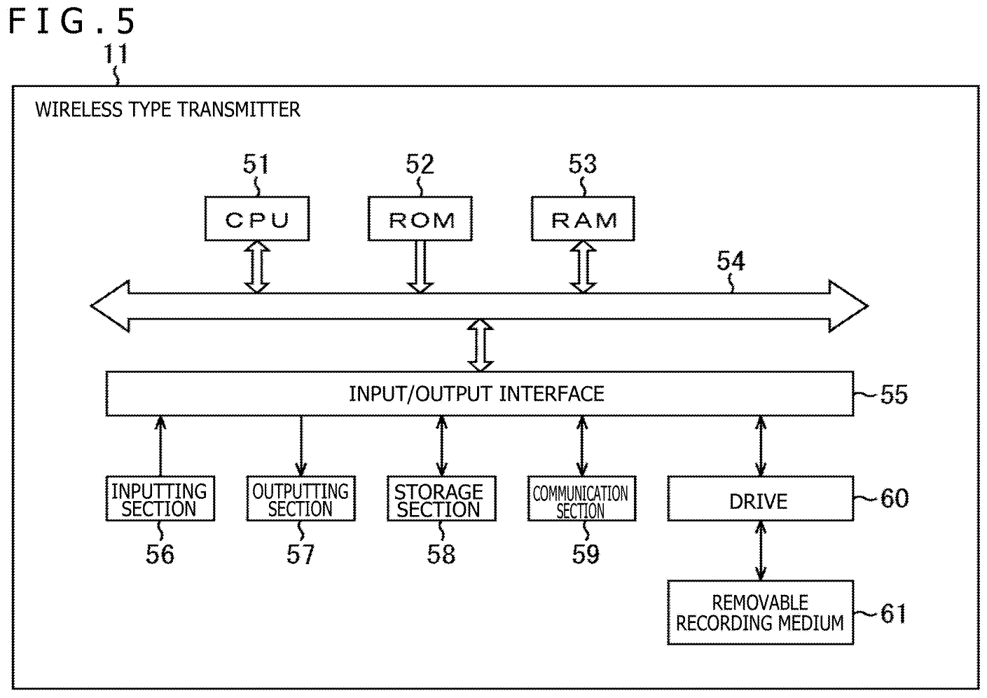

FIG. 5 is a block diagram depicting an example of a hardware configuration of the wireless type transmitter 11.

As depicted in FIG. 5, a CPU (Central Processing Unit) 51, a ROM (Read Only Memory) 52, and a RAM (Random Access Memory) 53 are connected to one another by a bus 54.

An input/output interface 55 is connected to the bus 54. An inputting section 56, an outputting section 57, a storage section 58, a communication section 59, and a drive 60 are connected to the input/output interface 55.

The inputting section 56 includes a touch panel, a keyboard, a mouse, and so forth. The inputting section 56 detects an operation performed by the user such as an operation for selecting content and outputs information representative of the substance of the operation performed by the user.

The outputting section 57 includes a display and so forth. The outputting section 57 displays, for example, information regarding the content being reproduced.

The storage section 58 stores a program to be executed by the CPU 51 and various kinds of data concerning content reproduced by execution of the program and so forth.

The communication section 59 is configured as a communication module compatible with wireless communication of Bluetooth or a wireless LAN. The communication section 59 performs communication with the wireless type receiver 12 or an external apparatus such as a server connected through the Internet. Content to be reproduced in the communication system 1 of FIG. 1 may be provided from a server through a network.

The drive 60 drives a removable medium 61 such as a memory card and performs writing of data into the removable medium 61 and reading out of data stored in the removable medium 61.

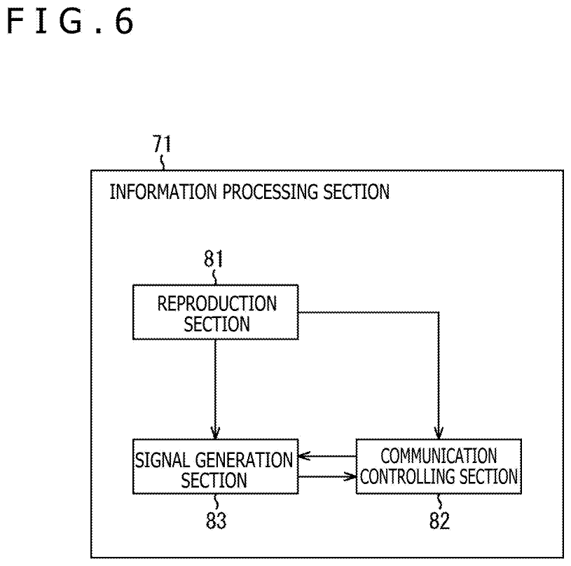

FIG. 6 is a block diagram depicting an example of a functional configuration of the wireless type transmitter 11.

In the wireless type transmitter 11, a predetermined program is executed by the CPU 51 of FIG. 5 to implement an information processing section 71 depicted in FIG. 6. The information processing section 71 includes a reproduction section 81, a communication controlling section 82, and a signal generation section 83.

The reproduction section 81 reproduces content to acquire an audio signal of the L channel and an audio signal of the R channel. In a case where wireless communication between the left wireless type receiver 12L and the right wireless type receiver 12R is not interrupted, an audio signal obtained by reproduction of the content is supplied to the communication controlling section 82.

On the other hand, in a case where wireless communication between the left wireless type receiver 12L and the right wireless type receiver 12R is interrupted, an audio signal obtained by reproduction of the content is supplied to the signal generation section 83.

The communication controlling section 82 controls the communication section 59 to transmit an audio signal of the L channel supplied from the reproduction section 81, to the left wireless type receiver 12L, and transmit an audio signal of the R channel to the right wireless type receiver 12R. Further, in a case where wireless communication with the left wireless type receiver 12L or the right wireless type receiver 12R is interrupted, the communication controlling section 82 transmits a transmission signal supplied from the signal generation section 83, to the connected receiver.

The communication controlling section 82 monitors the communication state of wireless communication with the left wireless type receiver 12L and the right wireless type receiver 12R. The communication state of wireless communication with a receiver includes a state of the bandwidth of the transmission path between the wireless type transmitter 11 and the receiver.

Further, the communication controlling section 82 monitors the communication state between the left wireless type receiver 12L and the right wireless type receiver 12R, for example, in reference to information transmitted from the left wireless type receiver 12L and the right wireless type receiver 12R. In such a manner, the communication controlling section 82 functions as a monitoring section for monitoring the state of wireless communication. Information representative of the communication state with the receivers and information representative of the communication state between the left wireless type receiver 12L and the right wireless type receiver 12R are supplied to the signal generation section 83.

The signal generation section 83 generates a transmission signal according to audio signals of the L channel and the R channel supplied from the reproduction section 81. The signal generation section 83 generates a transmission signal according to the communication state of wireless communication with the receivers and the communication state of wireless communication between the receivers, which are monitored by the communication controlling section 82. The transmission signal generated by the signal generation section 83 is supplied to the communication controlling section 82.

### Configuration of Wireless Type Receiver

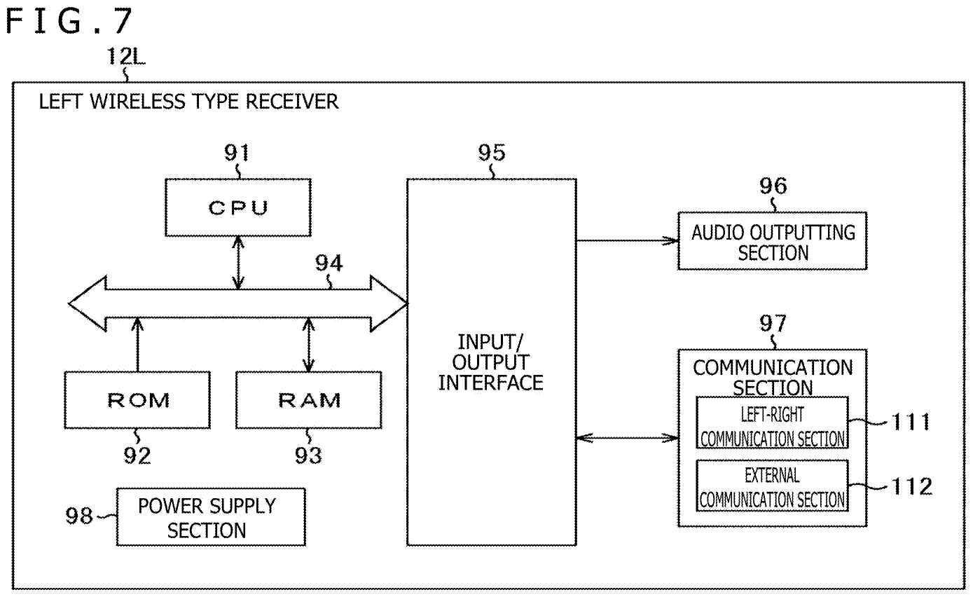

FIG. 7 is a block diagram depicting an example of a hardware configuration of the left wireless type receiver 12L.

As depicted in FIG. 7, the left wireless type receiver 12L includes a CPU 91, a ROM 92, a RAM 93, a bus 94, an input/output interface 95, an audio outputting section 96, a communication section 97, and a power supply section 98.

The CPU 91, the ROM 92, and the RAM 93 are connected to each other by the bus 94.

Further, the input/output interface 95 is connected to the bus 94. The audio outputting section 96 and the communication section 97 are connected to the input/output interface 95.

The audio outputting section 96 outputs audio according to an audio signal transmitted from the wireless type transmitter 11.

The communication section 97 includes a left-right communication section 111 and an external communication section 112.

The left-right communication section 111 is configured as a communication module compatible with wireless communication of Bluetooth, a wireless LAN, or NFMI. The left-right communication section 111 performs wireless communication with the right wireless type receiver 12R to exchange an audio signal with the right wireless type receiver 12R.

The external communication section 112 is configured as a communication module compatible with wireless communication of Bluetooth, a wireless LAN, or the like. The external communication section 112 performs communication with the wireless type transmitter 11 to receive an audio signal and so forth.

The power supply section 98 includes a battery. The power supply section 98 supplies electric power to the components of the left wireless type receiver 12L.

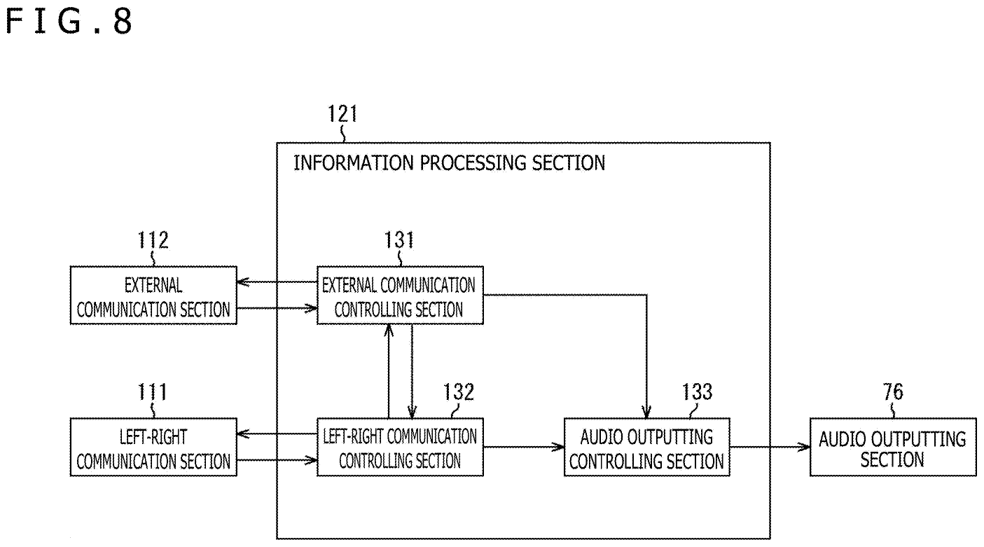

FIG. 8 is a block diagram depicting an example of a functional configuration of the left wireless type receiver 12L.

In the left wireless type receiver 12L, a predetermined program is executed by the CPU 91 of FIG. 7 to implement an information processing section 121 depicted in FIG. 8.

The information processing section 121 includes an external communication controlling section 131, a left-right communication controlling section 132, and an audio outputting controlling section 133.

The external communication controlling section 131 controls the external communication section 112 to perform wireless communication with the wireless type transmitter 11. The external communication controlling section 131 outputs a signal transmitted from the wireless type transmitter 11 and received by the external communication section 112 to the left-right communication controlling section 132 and the audio outputting controlling section 133.

Further, the external communication controlling section 131 transmits information supplied from the left-right communication controlling section 132, to the wireless type transmitter 11. For example, from the left-right communication controlling section 132, information representative of a state of wireless communication with the right wireless type receiver 12R is supplied.

The left-right communication controlling section 132 controls the left-right communication section 111 to perform wireless communication with the right wireless type receiver 12R. For example, the left-right communication controlling section 132 transmits an audio signal supplied from the external communication controlling section 131 to the right wireless type receiver 12R.

Further, the left-right communication controlling section 132 outputs an audio signal transmitted from the right wireless type receiver 12R and received by the left-right communication section 111 to the audio outputting controlling section 133.

The audio outputting controlling section 133 controls the audio outputting section 96 to output audio according to an audio signal supplied from the external communication controlling section 131 or the left-right communication controlling section 132.

It is to be noted that the right wireless type receiver 12R has a configuration similar to such a configuration of the left wireless type receiver 12L as described above.

### 3. Action of Apparatuses

### Action of Wireless Type Transmitter

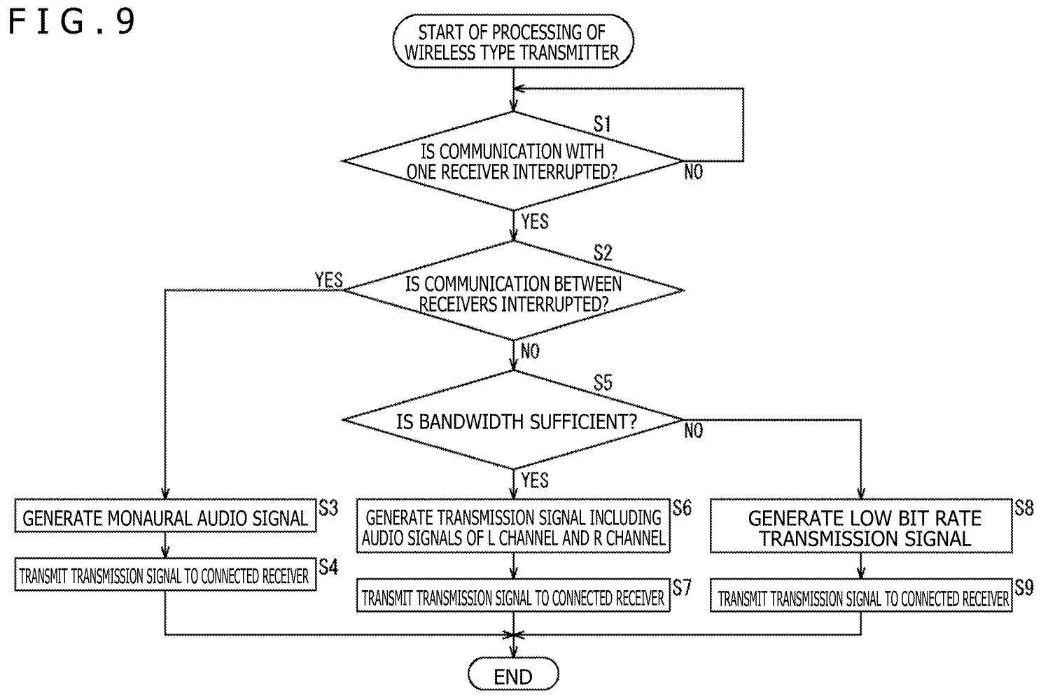

A process of the wireless type transmitter 11 is described with reference to a flow chart of FIG. 9.

The process of FIG. 9 is started when communication in a normal case is being performed, for example. An audio signal of the L channel obtained by reproduction of content is transmitted to the left wireless type receiver 12L, and an audio signal of the R channel obtained by reproduction of content is transmitted to the right wireless type receiver 12R.

In step S1, the communication controlling section 82 determines whether or not wireless communication with one of the left wireless type receiver 12L and the right wireless type receiver 12R is interrupted and waits until wireless communication with one of the receivers is determined to be interrupted.

In a case where it is determined in step S1 that wireless communication with one of the receivers is interrupted, the communication controlling section 82 determines in step S2 whether or not wireless communication between the receivers is interrupted.

In a case where it is determined in step S2 that wireless communication between the receivers is interrupted, the signal generation section 83 generates a monaural audio signal according to the audio signals of the L channel and the R channel in step S3.

In step S4, the communication controlling section 82 transmits the monaural audio signal as a transmission signal to the connected receiver.

On the other hand, in a case where it is determined in step S2 that wireless communication between the receivers is not interrupted, the communication controlling section 82 determines in step S5 whether or not the bandwidth of the communication path with the connected receiver is sufficient.

In a case where it is determined in step S5 that the bandwidth is sufficient, the signal generation section 83 generates a transmission signal including the audio signals of the L channel and the R channel in step S6. The transmission signal generated here is a signal that has not been subjected to such a process as compression, for example.

In step S7, the communication controlling section 82 transmits the transmission signal including the audio signals of the L channel and the R channel to the connected receiver.

In a case where it is determined in step S5 that the bandwidth is not sufficient, the signal generation section 83 generates a transmission signal of a low bit rate including the audio signals of the L channel and the R channel in step S8.

In step S9, the communication controlling section 82 transmits the transmission signal of the low bit rate to the connected receiver.

After transmission of the transmission signal is performed in step S4, step S7, or step S9, the processing is ended. Thereafter, the processes in the steps beginning with step S1 are performed repeatedly.

### Action of Wireless Type Receiver

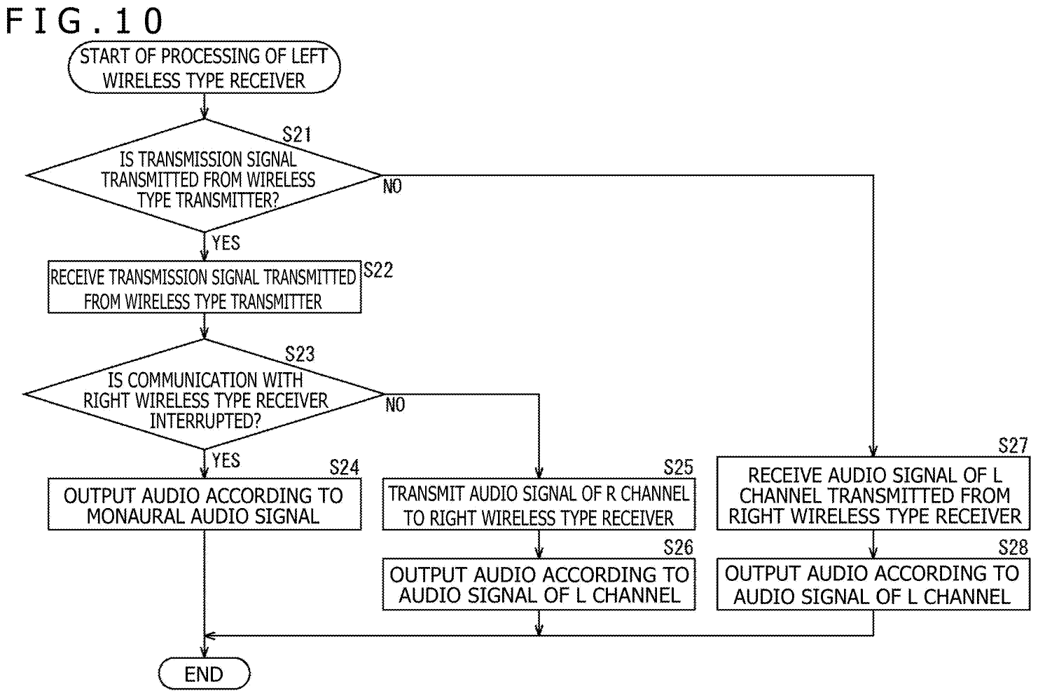

Processing of the left wireless type receiver 12L is described with reference to a flow chart of FIG. 10.

Also the processing of FIG. 10 is started, for example, when communication in a normal case is being performed. The left wireless type receiver 12L performs outputting of audio for the left ear according to an audio signal of the L channel transmitted from the wireless type transmitter 11.

In step S21, the external communication controlling section 131 determines whether or not a transmission signal is transmitted thereto from the wireless type transmitter 11.

In a case where it is determined in step S21 that a transmission signal is transmitted from the wireless type transmitter 11, the external communication section 112 receives the transmission signal in step S22.

In step S23, the left-right communication controlling section 132 determines whether or not wireless communication with the right wireless type receiver 12R is interrupted.

In a case where it is determined in step S23 that wireless communication with the right wireless type receiver 12R is interrupted, the audio outputting section 96 outputs audio according to a monaural audio signal as the transmission signal in step S24. In a case where wireless communication with the right wireless type receiver 12R is interrupted, a monaural audio signal is transmitted from the wireless type transmitter 11 as described hereinabove.

On the other hand, in a case where it is determined in step S23 that wireless communication with the right wireless type receiver 12R is not interrupted, the left-right communication controlling section 132 transmits the audio signal of the R channel included in the transmission signal to the right wireless type receiver 12R in step S25. In a case where wireless communication with the right wireless type receiver 12R is not interrupted, a signal including the audio signal of the L channel and the audio signal of the R channel is transmitted from the wireless type transmitter 11 as described hereinabove.

In step S26, the audio outputting section 96 outputs audio according to the audio signal of the L channel included in the transmission signal. It is to be noted that, also in a case where a transmission signal of a low bit rate is transmitted from the wireless type transmitter 11, processes similar to those in steps S25 and S26 are performed. The audio signal of the R channel of the low bit rate is transmitted to the right wireless type receiver 12R, and audio is outputted according to the audio signal of the L channel of the low bit rate.

In a case where it is determined in step S21 that a transmission signal is not transmitted from the wireless type transmitter 11, the left-right communication section 111 receives in step S27 the audio signal of the L channel transmitted from the right wireless type receiver 12R. In a case where wireless communication with the wireless type transmitter 11 is interrupted and a transmission signal is not transmitted thereto from the wireless type transmitter 11, the audio signal of the L channel is transmitted from the right wireless type receiver 12R that is the connected receiver as described hereinabove.

In step S28, the audio outputting section 96 outputs audio from the audio outputting section 96 according to the audio signal of the L channel. It is to be noted that, also in a case where an audio signal of the L channel of a low bit rate is transmitted from the right wireless type receiver 12R, processes similar to those in steps S27 and S28 are performed. Audio is outputted according to the audio signal of the L channel of the low bit rate transmitted from the right wireless type receiver 12R.

After outputting of audio is performed in step S24, step S27, or step S29, the processing is ended. Thereafter, the processes beginning with step S21 are performed repeatedly.

In the manner described above, in a case where wireless communication between the wireless type transmitter 11 and one of the receivers is interrupted, in the communication system 1, a transmission signal including the substance of an audio signal that has been transmitted to the unconnected receiver is transmitted to the connected receiver.

Since the audio signal that has been transmitted to the unconnected receiver is transmitted to the unconnected receiver via the connected receiver, it is possible for the communication system 1 to cause audio based on the audio signals of the L channel and the R channel to be outputted without interruption.

Further, since monaural audio is outputted from the connected receiver, the user can understand information represented by audio for the left ear and audio for the right ear. This makes it possible for the communication system 1 to prevent UX (User Experience) from deteriorating in that information cannot be understood because of interruption of the audio.

In such a manner, the communication system 1 not only transmits an audio signal that has been transmitted to the unconnected receiver as it is to the unconnected receiver via the connected receiver but also can cause the connected receiver to output an audio signal for which information processing such as conversion to monaural has been performed, in order that a human can understand the substance of the audio with use of perceptual information processing.

### 4. Modification

Although there has been described the example in which, in a case where wireless communication between the wireless type transmitter 11 and a receiver is interrupted completely, a transmission signal including the substance of an audio signal that has been transmitted to the unconnected receiver is transmitted to the connected receiver, such a transmission signal as described above may otherwise be transmitted to the connected receiver in a case where the communication state of wireless communication between the wireless type transmitter 11 and a receiver gets worse.

For example, in a case where the bandwidth of the communication path between the wireless type transmitter 11 and a receiver becomes narrower, in a case where the strength of the radio wave that connects the wireless type transmitter 11 and a receiver decreases, or in a similar case, a transmission signal is transmitted to the receiver whose wireless communication with the wireless type transmitter 11 has not gotten worse.

Although it is described in the foregoing description that the wireless type receiver 12 outputs audio, the audio that is outputted from the wireless type receiver 12 includes not only voice of a human but also various kinds of audio such as music, effect sound, or BGM. Also it is possible to apply the technology described above to a case where a signal other than an audio signal is transmitted.

Although it is described that the wireless type receiver 12 is earphones of the fully independent type, the technology described hereinabove can be applied to various receivers each of which can independently perform communication with the wireless type transmitter 11 and can perform communication between different receivers. For example, various devices such as a speaker, a camera, or a display are used as the receivers.

Although it is described that the wireless type receiver 12 is configured as devices of two housings, it may otherwise be configured as devices of three or more housings.

### Others

Although the series of processes described above can be executed by hardware, it can otherwise be executed also by software. In the case where the series of processes is executed by software, a program that constructs the software is installed into a computer incorporated in hardware for exclusive use, a personal computer for universal use, or the like.

The program to be installed is recorded on and provided as a removable medium such as an optical disk (CD-ROM (Compact Disc-Read Only Memory), a DVD (Digital Versatile Disc), or the like), or a semiconductor memory. Alternatively, the program may be provided through a wired or wireless transmission medium such as a local area network, the Internet, or a digital broadcast. The program can be installed in a ROM or a storage section in advance.

It is to be noted that the program to be executed by a computer may be a program by which processes are executed in a time series in the order described in the present specification or may be a program by which processes are executed in parallel or are executed individually at necessary timings such as when they are called.

In the present specification, the term system is used to signify an aggregation of multiple components (apparatuses, modules (parts), and so forth), and it does not matter whether or not all components are accommodated in the same housing. Accordingly, multiple apparatuses accommodated in separate housings and connected to each other through a network are a system, and also one apparatus in which multiple modules are accommodated in a single housing is a system.

It is to be noted that the advantageous effects described in the present specification are exemplary to the last and are not restrictive, and other advantageous effects may be available.

The embodiments of the present technology are not restricted to the embodiment described hereinabove, and various alterations are possible without departing from the subject matter of the present technology.

Further, the steps described with reference to the flow charts described above can not only be executed by one device but also be shared and executed by multiple devices.

### Example of Combination of Configurations

The present technology can assume also such configurations as described below.

(1)
A transmission apparatus including:
a communication section that transmits, in a case where wireless communication thereof with one of multiple receivers that perform wireless communication with each other is interrupted, a transmission signal including substance of a signal that has been transmitted directly to an unconnected receiver that is the receiver with which wireless communication is interrupted, to a connected receiver that is the receiver with which wireless communication is not interrupted.

(2)
The transmission apparatus according to (1) above, further including:
a signal generation section that generates the transmission signal according to a signal to be transmitted to the connected receiver and a signal to be transmitted to the unconnected receiver.

(3)
The transmission apparatus according to (2) above, in which
the signal generation section generates the transmission signal according to a communication state of wireless communication with the connected receiver and a communication state of wireless communication between the connected receiver and the unconnected receiver.

(4)
The transmission apparatus according to (3) above, in which,
in a case where wireless communication between the connected receiver and the unconnected receiver is interrupted, the signal generation section generates the transmission signal of a monaural type according to the signal to be transmitted to the connected receiver and the signal to be transmitted to the unconnected receiver.

(5)
The transmission apparatus according to (3) or (4) above, in which,
in a case where wireless communication between the connected receiver and the unconnected receiver is not interrupted, the signal generation section generates the transmission signal that includes the signal to be transmitted to the connected receiver and the signal to be transmitted to the unconnected receiver.

(6)
The transmission apparatus according to (5) above, in which,
in a case where a bandwidth of wireless communication with the connected receiver is smaller than a threshold level, the signal generation section generates the transmission signal that includes the signal to be transmitted to the connected receiver and the signal to be transmitted to the unconnected receiver and has a lowered bit rate.

(7)
The transmission apparatus according to any one of (3) through (6) above, further including:
a monitoring section that monitors a communication state of wireless communication with the receivers and a communication state of wireless communication between the receivers.

(8)
A transmission method including:
transmitting, in a case where wireless communication with one of multiple receivers that perform wireless communication with each other is interrupted, a transmission signal including substance of a signal that has been transmitted directly to an unconnected receiver that is the receiver with which wireless communication is interrupted, to a connected receiver that is the receiver with which wireless communication is not interrupted.

(9)
A reception apparatus including:
multiple receivers that perform wireless communication with each other, in which
a connected receiver that is one of the receivers and whose wireless communication with a transmission apparatus is not interrupted includes
   an external communication section that receives a transmission signal that is transmitted from the transmission apparatus and that includes substance of a signal that has been transmitted from the transmission apparatus directly to an unconnected receiver that is one of the receivers and whose wireless communication with the transmission apparatus is interrupted, and
   a mutual communication section that transmits a signal that is included in the transmission signal and that has been transmitted from the transmission apparatus to the unconnected receiver to the unconnected receiver, and
the unconnected receiver includes a mutual communication section that receives the signal transmitted from the connected receiver.

(10)
The reception apparatus according to (9) above, in which
the connected receiver further includes an audio outputting section that outputs audio according to the transmission signal transmitted from the transmission apparatus, and
the unconnected receiver further includes an audio outputting section that outputs audio according to a signal transmitted from the connected receiver.

(11)
A reception method in which
a connected receiver that is a receiver among multiple receivers that perform wireless communication with each other and whose wireless communication with a transmission apparatus is not interrupted
   receives a transmission signal that is transmitted from the transmission apparatus and that includes substance of a signal that has been transmitted from the transmission apparatus directly to an unconnected receiver that is one of the receivers and whose wireless communication with the transmission apparatus is interrupted, and
   transmits a signal that is included in the transmission signal and that has been transmitted from the transmission apparatus to the unconnected receiver to the unconnected receiver, and
the unconnected receiver receives the signal transmitted from the connected receiver.

(12)
A communication system including:
a transmission apparatus that includes a communication section that transmits, in a case where wireless communication with one of multiple receivers that perform wireless communication with each other is interrupted, a transmission signal including substance of a signal that has been transmitted directly to an unconnected receiver that is one of the receivers and whose wireless communication is interrupted, to a connected receiver that is one of the receivers and whose wireless communication is not interrupted; and
a reception apparatus including the multiple receivers, in which
the connected receiver includes
   an external communication section that receives the transmission signal transmitted from the transmission apparatus, and
   a mutual communication section that transmits a signal that is included in the transmission signal and that has been transmitted from the transmission apparatus to the unconnected receiver to the unconnected receiver, and
the unconnected receiver includes a mutual communication section that receives the signal transmitted from the connected receiver.

### REFERENCE SIGNS LIST

1: Communication system
11: Wireless type transmitter
12: Wireless type receiver
12L: Left wireless type receiver
12R: Right wireless type receiver
59: Communication section
71: Information processing section
81: Reproduction section
82: Communication controlling section
83: Signal generation section
96: Audio outputting section
111: Left-right communication section
112: External communication section
121: Information processing section
131: External communication controlling section
132: Left-right communication controlling section
133: Audio outputting controlling section

1. A transmission apparatus comprising:
a communication section that transmits, in a case where wireless communication thereof with one of multiple receivers that perform wireless communication with each other is interrupted, a transmission signal including substance of a signal that has been transmitted directly to an unconnected receiver that is the receiver with which wireless communication is interrupted, to a connected receiver that is the receiver with which wireless communication is not interrupted.

2. The transmission apparatus according to claim 1, further comprising:
a signal generation section that generates the transmission signal according to a signal to be transmitted to the connected receiver and a signal to be transmitted to the unconnected receiver.

3. The transmission apparatus according to claim 2, wherein
the signal generation section generates the transmission signal according to a communication state of wireless communication with the connected receiver and a communication state of wireless communication between the connected receiver and the unconnected receiver.

4. The transmission apparatus according to claim 3, wherein,
in a case where wireless communication between the connected receiver and the unconnected receiver is interrupted, the signal generation section generates the transmission signal of a monaural type according to the signal to be transmitted to the connected receiver and the signal to be transmitted to the unconnected receiver.

5. The transmission apparatus according to claim 3, wherein,
in a case where wireless communication between the connected receiver and the unconnected receiver is not interrupted, the signal generation section generates the transmission signal that includes the signal to be transmitted to the connected receiver and the signal to be transmitted to the unconnected receiver.

6. The transmission apparatus according to claim 5, wherein,
in a case where a bandwidth of wireless communication with the connected receiver is smaller than a threshold level, the signal generation section generates the transmission signal that includes the signal to be transmitted to the connected receiver and the signal to be transmitted to the unconnected receiver and has a lowered bit rate.

7. The transmission apparatus according to claim 3, further comprising:
a monitoring section that monitors a communication state of wireless communication with the receivers and a communication state of wireless communication between the receivers.

8. A reception apparatus comprising:
multiple receivers that perform wireless communication with each other, wherein
a connected receiver that is one of the receivers and whose wireless communication with a transmission apparatus is not interrupted includes
an external communication section that receives a transmission signal that is transmitted from the transmission apparatus and that includes substance of a signal that has been transmitted from the transmission apparatus directly to an unconnected receiver that is one of the receivers and whose wireless communication with the transmission apparatus is interrupted, and
a mutual communication section that transmits a signal that is included in the transmission signal and that has been transmitted from the transmission apparatus to the unconnected receiver to the unconnected receiver, and
the unconnected receiver includes a mutual communication section that receives the signal transmitted from the connected receiver.

9. The reception apparatus according to claim 8, wherein
the connected receiver further includes an audio outputting section that outputs audio according to the transmission signal transmitted from the transmission apparatus, and
the unconnected receiver further includes an audio outputting section that outputs audio according to a signal transmitted from the connected receiver.

10. A communication system comprising:
a transmission apparatus that includes a communication section that transmits, in a case where wireless communication with one of multiple receivers that perform wireless communication with each other is interrupted, a transmission signal including substance of a signal that has been transmitted directly to an unconnected receiver that is one of the receivers and whose wireless communication is interrupted, to a connected receiver that is one of the receivers and whose wireless communication is not interrupted; and
a reception apparatus including the multiple receivers, wherein
the connected receiver includes
an external communication section that receives the transmission signal transmitted from the transmission apparatus, and
a mutual communication section that transmits a signal that is included in the transmission signal and that has been transmitted from the transmission apparatus to the unconnected receiver to the unconnected receiver, and
the unconnected receiver includes a mutual communication section that receives the signal transmitted from the connected receiver.
